(19) United States
(12) Patent Application Publication
(10) Pub. No.: US 2025/0202990 A1
(43) Pub. Date: Jun. 19, 2025

(54) INTEREST ESTIMATION DEVICE

(71) Applicant: NTT DOCOMO, INC., Tokyo (JP)

(72) Inventors: Akinari SAKAI, Chiyoda-ku (JP); Yusuke NAKAMURA, Chiyoda-ku (JP); Akira YAMADA, Chiyoda-ku (JP); Takashi SUZUKI, Chiyoda-ku (JP)

(73) Assignee: NTT DOCOMO, INC., Tokyo (JP)

(21) Appl. No.: 18/846,791

(22) PCT Filed: Mar. 24, 2023
(86) PCT No.: PCT/JP2023/012029

§ 371 Date: Sep. 13, 2024

(30) Foreign Application Priority Data
May 2, 2022 (JP) 2022-076130

(51) Int. Cl. H04L 67/306

(52) U.S. Cl. CPC H04L 67/306

(57) ABSTRACT

An object is to estimate interest of a user in a content on the basis of a cognitive bias of the user. An interest estimation device (1) includes a storage unit (11) that stores cognitive bias tendency information relating to a cognitive bias present in tendency of a user expressing interest in a predetermined content, an acquisition unit (10) that acquires user cognitive bias information relating to a cognitive bias of a target user who is a user to be targeted, and an estimation unit (13) that estimates interest of the target user in the content on the basis of the cognitive bias tendency information stored by the storage unit (11) and the user cognitive bias information acquired by the acquisition unit (10).

### TECHNICAL FIELD

One aspect of the present disclosure relates to an interest estimation device that estimates a user's interest in a content.

### BACKGROUND ART

In the following Patent Literature 1, a processing device that expresses selection behaviors of consumers to whom a cognitive bias is applied as a model is disclosed.

### CITATION LIST

### Patent Literature

Patent Literature 1: Japanese Unexamined Patent Publication No. 2016-115316

### SUMMARY OF INVENTION

### Technical Problem

In the processing device described above, for example, interest of a consumer in a product cannot be estimated on the basis of a cognitive bias of the consumer. Thus, it is preferable to estimate interest of a user in a content on the basis of a cognitive bias of the user.

### Solution to Problem

According to one aspect of the present disclosure, there is provided an interest estimation device including: a storage unit configured to store cognitive bias tendency information relating to a cognitive bias present in tendency of a user expressing interest in a predetermined content; an acquisition unit configured to acquire user cognitive bias information relating to a cognitive bias of a target user who is a user to be targeted; and an estimation unit configured to estimate interest of the target user in the content on the basis of the cognitive bias tendency information stored by the storage unit and the user cognitive bias information acquired by the acquisition unit.

In such an aspect, interest of a target user in a content is estimated on the basis of user cognitive bias information of the target user. In other words, interest of a user in a content can be estimated on the basis of a cognitive bias of the user.

### Advantageous Effects of Invention

According to one aspect of the present disclosure, interest of a user in a content can be estimated on the basis of a cognitive bias of the user.

### BRIEF DESCRIPTION OF DRAWINGS

FIG. 1 A diagram illustrating one example of the functional configuration of an interest estimation device according to an embodiment.

FIG. 2 A diagram illustrating an example of a table of user cognitive bias information.

FIG. 3 A diagram illustrating an example of a table of cognitive bias tendency information.

FIG. 4 A diagram illustrating an example of a table of real world visit information.

FIG. 5 A diagram illustrating an example of a table of virtual world visit information.

FIG. 6 A diagram illustrating an example of a table of cognitive bias information.

FIG. 7 A diagram illustrating an example of a table of extracted cognitive bias information.

FIG. 8 A sequence diagram illustrating one example of a cognitive bias tendency information calculating process executed by an interest estimation device according to an embodiment.

FIG. 9 A sequence diagram illustrating one example of an interest estimating process executed by an interest estimation device according to an embodiment.

FIG. 10 A diagram illustrating one example of the hardware configuration of a computer used by an interest estimation device according to an embodiment.

### DESCRIPTION OF EMBODIMENTS

Hereinafter, an embodiment of the present disclosure will be described in detail with reference to the drawings. In description of the drawings, the same reference signs will be assigned to the same elements, and duplicate description will be omitted. In addition, the embodiment of the present disclosure in the following description is a specific example of the present invention, and the present invention is not limited to such an embodiment unless there is description for the purpose of limiting the present invention.

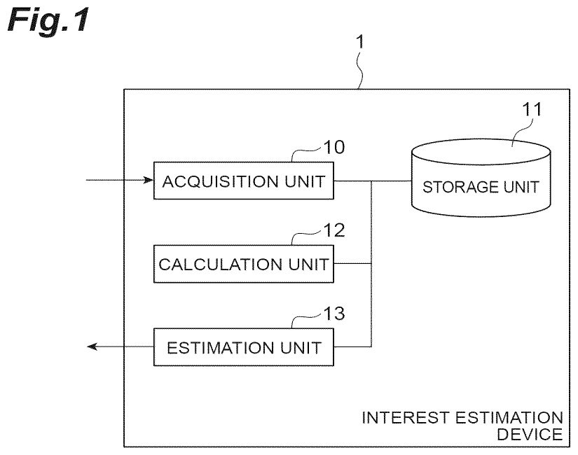

FIG. 1 is a diagram illustrating one example of the functional configuration of an interest estimation device 1 according to an embodiment. The interest estimation device 1 is a computer device that estimates interest (preferences, tastes and preferences) of a user in a predetermined content.

A content, for example, is a store, a facility, an object, information, or the like for an economic activity or entertainment. In this embodiment, contents are assumed to be present in each of a virtual world and a real world. A content, for example, is a music event, an apparel shop, or the like. By accessing (visiting) a content, a user can use this content.

The virtual world is a virtual two-dimensional or three-dimensional world (space). In this embodiment, a term “world” may be appropriately substituted with “space”, and, to the contrary, a term “space” may be appropriately substituted with “world”. The virtual world, for example, may be a metaverse that is a three-dimensional space different from a real world that is built on a computer or a computer network (the Internet or the like).

As illustrated in FIG. 1, the interest estimation device 1 is configured to include an acquisition unit 10 (acquisition unit), a storage unit 11 (storage unit), a calculation unit 12 (calculation unit), and an estimation unit 13 (estimation unit).

Although each functional block of the interest estimation device 1 is assumed to function inside the interest estimation device 1, the configuration is not limited thereto. For example, some of the functional blocks of the interest estimation device 1 may function while appropriately transmitting/receiving information to/from the interest estimation device 1 inside a computer device that is a computer device different from the interest estimation device 1 and is connected to the interest estimation device 1 through a network. In addition, some of the functional blocks of the interest estimation device 1 may be omitted, a plurality of functional blocks may be integrated into one functional block, and one functional block may be divided into a plurality of functional blocks.

Hereinafter, each function of the interest estimation device 1 illustrated in FIG. 1 will be described.

The acquisition unit 10 acquires user cognitive bias information relating to a cognitive bias of a target user who is a user to be targeted.

A cognitive bias is a psychological phenomenon in which judgments and the like of things become irrational due to intuitions or preconceived notions based on past experiences or a psychological phenomenon in which unreasonable decisions are made unconsciously due to personal beliefs, surrounding environments, or the like. The cognitive bias may be substituted with a psychological tendency.

The user cognitive bias information may include a degree of cognitive bias of a target user. The user cognitive bias information may include information relating a plurality of cognitive biases of a target user.

The degree of cognitive bias, for example, is a real number from “0” to “1”, and it may be configured such that, as it becomes closer to “0”, the lower the degree (tendency) becomes, and as it becomes closer to “1”, the higher the degree (tendency) becomes.

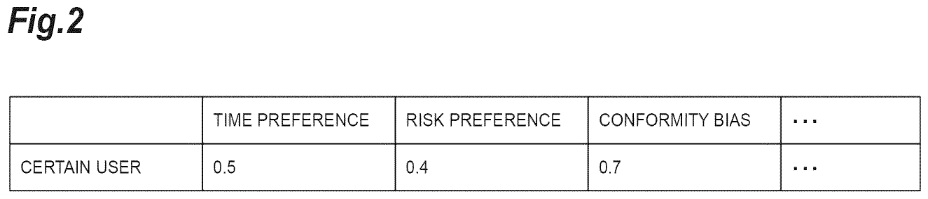

FIG. 2 is a diagram illustrating an example of a table of user cognitive bias information. In the example of the table of user cognitive bias information illustrated in FIG. 2, a degree of time preference that is a cognitive bias of a target user, a degree of risk preference that is a cognitive bias of the target user, a degree of conformity bias that is a cognitive bias of the target user, and degrees of other cognitive biases of the target user are associated with a “certain user” who is the target user. The time preference, the risk preference, the conformity bias, and the like are a plurality of cognitive biases of the target user.

The acquisition unit 10 may acquire various kinds of information that is used by the interest estimation device 1. The various information, for example, is cognitive bias tendency information, visit information, and cognitive bias information to be described below in addition to the user cognitive bias information described above. The acquisition unit 10 may acquire (receive) various kinds of information from other devices through a network or may acquire various information from the storage unit 11 in which the information is stored in advance.

The acquisition unit 10 may output various kinds of information that have been acquired to the calculation unit 12 and the estimation unit 13 or may store the information by the storage unit 11.

The storage unit 11 stores cognitive bias tendency information relating to a cognitive bias that is present in tendencies of a user expressing interest in a predetermined content.

The cognitive bias tendency information may include information relating to a cognitive bias that is present in tendencies of a user expressing interest in a content in a virtual world. The cognitive bias tendency information may include information relating to a cognitive bias that is present in the tendencies of a user expressing interest in a content in the real world. The cognitive bias tendency information may include information relating to a cognitive bias that is present in the tendencies of a user expressing interest in a content in a virtual world and information relating to a cognitive bias that is present in the tendency of a user expressing interest in a content in the real world. The cognitive bias tendency information may include a degree of a cognitive bias that is present in the tendency of a user expressing interest in a content. The cognitive bias tendency information may include information relating to a plurality of cognitive biases that are present in the tendency of a user expressing interest in a content.

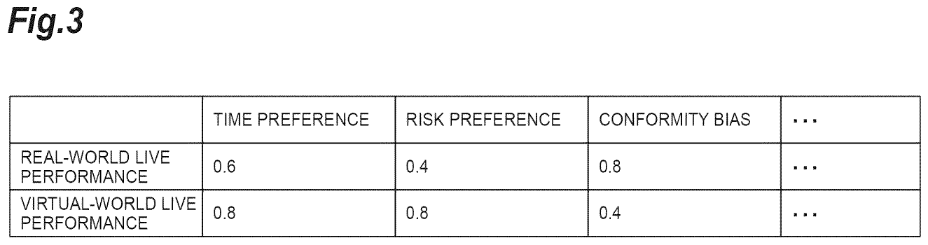

FIG. 3 is a diagram illustrating an example of a table of cognitive bias tendency information. In the example of the table of the user cognitive bias information illustrated in FIG. 3, a degree of time preference that is a cognitive bias present in the tendency of a user expressing interest in a content, a degree of risk preference that is a cognitive bias present in the tendency of a user expressing interest in the content, a degree of conformity bias that is a cognitive bias present in the tendency of a user expressing interest in the content, and degrees of other cognitive biases present in the tendency of a user expressing interest in the content are associated with each of a “real-world live performance” that is a live performance of a predetermined content in the real world and a “virtual live performance” that is a live performance of a predetermined content in the virtual world. The time preference, the risk preference, the conformity bias, and the like are a plurality of cognitive biases present in the tendency of a user expressing interest in a content.

As in the example of the table of the user cognitive bias information illustrated in FIG. 3, generally, biases function differently in contents of the real world and a virtual world, and thus a weight of a cognitive bias is different for each content. As a specific example, a person having a high conformity bias and a high time preference will be assumed. Regarding lunch choices in the real world, the weight of the time preference becomes strong, and thus lines are avoided (there is a tendency of avoiding lines). On the other hand, in a virtual world in which it is unlikely for time to be wasted due to congestion, the weight of the conformity bias becomes strong, and it becomes likely to take the same behavior as other persons (there is a tendency of taking the same behavior as the other persons).

The storage unit 11 may store cognitive bias tendency information calculated by the calculation unit 12 to be described below. The storage unit 11 may store the above-described various kinds of information used by the interest estimation device 1.

In addition thereto, the storage unit 11 may store arbitrary information used in calculation and the like in the interest estimation device 1 and results of calculation and the like in the interest estimation device 1. The information stored by the storage unit 11 may be appropriately referred to using each function of the interest estimation device 1.

The calculation unit 12 calculates cognitive bias tendency information on the basis of information relating to accesses to a content from a plurality of users (visit information) and information relating to cognitive biases of these users (cognitive bias information).

In the visit information, information relating to accesses to contents in the real world from a plurality of users will be referred to as real world visit information, and information relating to accesses to contents in a virtual world from a plurality of users will be referred to as real world visit information.

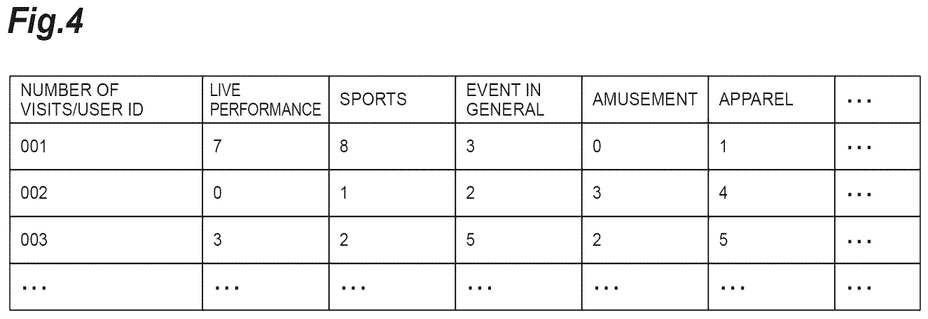

FIG. 4 is a diagram illustrating an example of a table of real world visit information. In the example of the table of the real world visit information illustrated in FIG. 4, a user ID for identifying a user, the number of visits (the number of accesses) to live performance, which is a content in the real world, from this user, the number of visits to sports, which is a content in the real world, from this user, the number of visits to an event in general, which represents a content in the real world, from this user, the number of visits to amusement, which is a content in the real world, from this user, the number of visits to apparel, which is a content in the real world, from this user, and the number of visits to other contents in the real world from this user are associated with each other.

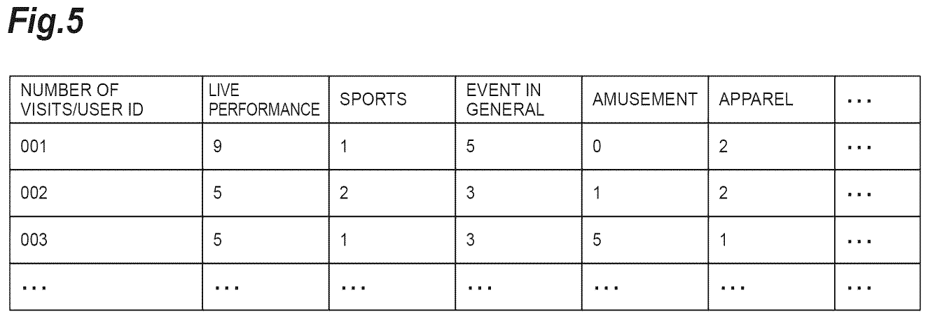

FIG. 5 is a diagram illustrating an example of a table of virtual world visit information. In the example of the table of the virtual world visit information illustrated in FIG. 5, a user ID for identifying a user, the number of visits (the number of accesses) to live performance, which is a content in the virtual world, from this user, the number of visits to sports, which is a content in the virtual world, from this user, the number of visits to an event in general, which represents a content in the virtual world, from this user, the number of visits to amusement, which is a content in the virtual world, from this user, the number of visits to apparel, which is a content in the virtual world, from this user, and the number of visits to other contents in the virtual world from this user are associated with each other.

As in the example of the table of the real world visit information illustrated in FIG. 4 and the example of the table of the virtual world visit information illustrated in FIG. 5, generally, the same user has different tendencies of preferences in the real world and the virtual world.

The cognitive bias information is calculated by basically acquiring a user's psychological tendency through surveys and the like. An example of a survey question to measure a time preference is “Which would you prefer: a job with a consistently average income from the start or a job with a low starting salary that eventually leads to a high salary?” In addition, an example of a survey question to measure a risk preference is: “How much would you be willing to pay as a maximum for a lottery ticket that has a 10% chance of winning 300,000 yen?” Cognitive biases may be measured through surveys based on behavioral economics.

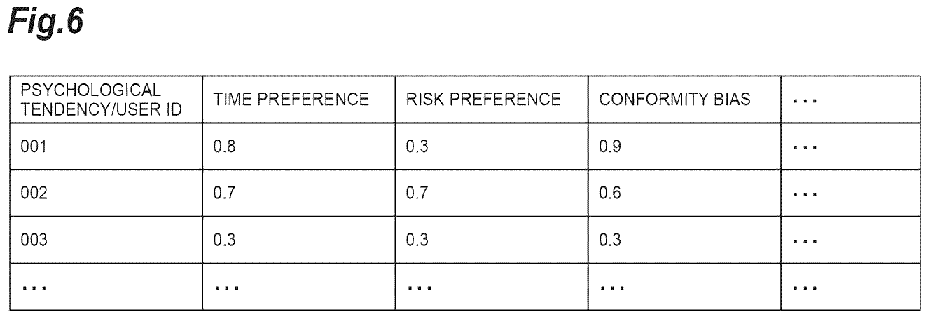

FIG. 6 is a diagram illustrating an example of a table of cognitive bias information. In the example of the table of the cognitive bias information illustrated in FIG. 6, a user ID for identifying a user, a degree of time preference that is a cognitive bias of this user, a degree of risk preference that is a cognitive bias of this user, a degree of conformity bias that is a cognitive bias of this user, and degrees of other cognitive biases of this user are associated with each other.

Although an example of calculation of cognitive bias tendency information using the calculation unit 12 will be described below, the configuration is not limited thereto. The calculation unit 12 acquires a log of accessing (visiting) a specific content and averages psychological tendencies of the visit log (in the case of a plurality of number of visits, they are counted as a plurality of logs), thereby calculating the cognitive bias tendency information.

More specifically, first, the calculation unit 12 acquires user logs of which the number of visits for a focused content is one or more. For example, in a case in which a live performance that is a content in the real world is focused, as users whose numbers of visits for a live performance column is one or more in the example of the table in the real world visit information illustrated in FIG. 4, users whose user IDs are “001”, “003”, and the like are extracted. Next, the calculation unit 12 extracts cognitive bias information of the extracted users as extracted cognitive bias information.

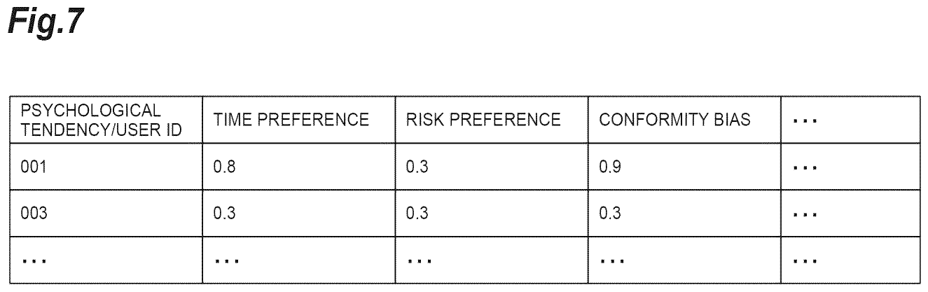

FIG. 7 is a diagram illustrating an example of a table of extracted cognitive bias information. The configuration of the example of the table of the extracted cognitive bias information illustrated in FIG. 7 is similar to that of the example of the table of the cognitive bias information illustrated in FIG. 6. The example of the table of the extracted cognitive bias information illustrated in FIG. 7 is acquired by extracting only users of which the number of visits for a live performance column is one or more from the example of the table of the cognitive bias information illustrated in FIG. 6.

Next, by averaging cognitive biases of the extracted cognitive bias information (this combination is analyzed to visit this content the most easily), the calculation unit 12 calculates cognitive bias tendency information. The cognitive bias tendency information relating to a live performance in the real world that has been calculated on the basis of the calculation example of the calculation unit 12 described above corresponds to a “real-world live performance” row of the example of the table of the cognitive bias tendency information illustrated in FIG. 3. Similarly, also in a case in which a live performance that is a content in the virtual world is focused, the calculation unit 12 calculates cognitive bias tendency information corresponding to a “virtual live performance” row of the example of the table of the cognitive bias tendency information illustrated in FIG. 3 by using the example of the table of the virtual world visit information illustrated in FIG. 5. The calculation unit 12 calculate cognitive bias tendency information for each content of each of the real world and the virtual world.

The calculation unit 12 may store the calculated cognitive bias tendency information using the storage unit 11 or may output the calculated cognitive bias tendency information to the estimation unit 13.

The calculation unit 12 may calculate cognitive bias tendency information without using visit information (there may be no visit result).

The estimation unit 13 estimates interest of a target user in a content on the basis of the cognitive bias tendency information stored by the storage unit 11 and the user cognitive bias information acquired (input) by the acquisition unit 10.

The estimation unit 13 may estimate interest of a target user in a content in the virtual world. The estimation unit 13 may (simultaneously) estimate interest of a target user in a content in the real world. The estimation unit 13 may estimate interest of a target user in a content in the virtual world and interest of the target user in a content in the real world.

The estimation unit 13 may estimate interest of a target user in a content on the basis of a degree of cognitive bias included in the cognitive bias tendency information and a degree of cognitive bias included in the user cognitive bias information. The estimation unit 13 may estimate interest of a target user in a content on the basis of a difference between a degree of cognitive bias included in the cognitive bias tendency information and a degree of cognitive bias included in the user cognitive bias information.

Although an example of estimation of interest using the estimation unit 13 will be described below, the estimation is not limited thereto. The estimation unit 13 calculates an error from a cognitive bias of a user for each content. Here, variables used at the time of calculation will be described.

A degree (cognitive bias score) of a cognitive bias of a certain real content (a cognitive bias present in the tendency of a user expressing interest in this content) is represented using the following variables.

$${RCBS}_{n}^{m} \qquad [ Math . 1 ]$$

Here, m represents a number for each content, and n represents a number for each cognitive bias. For example, a “real-world live performance” row in the example of the table of the cognitive bias tendency information illustrated in FIG. 3 corresponds to the variables described above, and, for example, the live performance is “m=1”, the time preference is “n=1”, the risk preference is “n=2”, the conformity bias is “n=3”, and the like.

Similarly, a degree (a cognitive bias score) of a cognitive bias of a certain virtual content (a cognitive bias present in the tendency of a user expressing interest in this content) is represented using the following variables.

$${VCBS}_{n}^{m} \qquad [ Math . 2 ]$$

Here, as described above, m represents a number for each content, and, as described above, n represents a number for each cognitive bias. For example, a “virtual live performance” row in the example of the table of the cognitive bias tendency information illustrated in FIG. 3 corresponds to the variables described above, and, for example, the live performance is “m=1”, the time preference is “n=1”, the risk preference is “n=2”, the conformity bias is “n=3”, and the like.

An unknown cognitive bias of a certain user for which a degree of interest (a preference score) is desired to be calculated will be denoted as a variable BSₙ. As described above, n represents a number (or a type of bias) for each cognitive bias. For example, the example of the table of the user cognitive bias information illustrated in FIG. 2 corresponds to the variable described, and, for example, the time preference is “n=1”, the risk preference is “n=2”, the conformity bias is “n=3”, and the like. BSₙ may take a value between “0” and “1”.

By using the variables described above, the estimation unit 13 calculates a preference score of a certain real-world content of a certain user by measuring an error from the cognitive bias score for each content on the basis of the following Equation (1).

$$\begin{matrix}[ Math . 3 ] & \\ 1 - \frac{{\sum }_{n = 1}^{N} \vert {RCBS}_{n}^{m} - {BS}_{n} \vert}{N} & ( 1 )\end{matrix}$$

For example, when values of the example of the table of the user cognitive bias information illustrated in FIG. 2 and the example of the table of the cognitive bias tendency information illustrated in FIG. 3 are applied to Equation (1) (for simplification of description, only numerical values present in the examples of the tables are set as calculation targets), 1−(|0.5−0.6|+|0.4−0.4|+|0.7−0.8|)/N=0.933, and the calculated “0.933” is the preference score.

Equation (1) may be (substituted with) the following Equation (2).

$$\begin{matrix}[ Math . 4 ] & \\ 1 - \frac{{\sum }_{n = 1}^{N} {( {RCBSn}_{n}^{m} - {BS}_{n} )}^{2}}{N} & ( 2 )\end{matrix}$$

Other than that, the estimation unit 13 may estimate interest on the basis of a cosine similarly or the like.

Similarly, the estimation unit 13 calculates a preference score of a certain virtual-world content of a certain user by measuring an error from the cognitive bias score for each content on the basis of the following Equation (3).

$$\begin{matrix}[ Math . 5 ] & \\ 1 - \frac{{\sum }_{n = 1}^{N} \vert {VCBS}_{n}^{m} - {BS}_{n} \vert}{N} & ( 3 )\end{matrix}$$

For example, when values of the example of the table of the user cognitive bias information illustrated in FIG. 2 and the example of the table of the cognitive bias tendency information illustrated in FIG. 3 are applied to Equation (3) (for simplification of description, only numerical values present in the examples of the tables are set as calculation targets), 1−(|0.5−0.8|+|0.4−0.8|+|0.7−0.4|)/N=0.67, and the calculated “0.67” is the preference score.

The estimation unit 13 may output (display) the result of the estimation to a user of the interest estimation device 1 or may output (transmit) the result of the estimation to another device through a network.

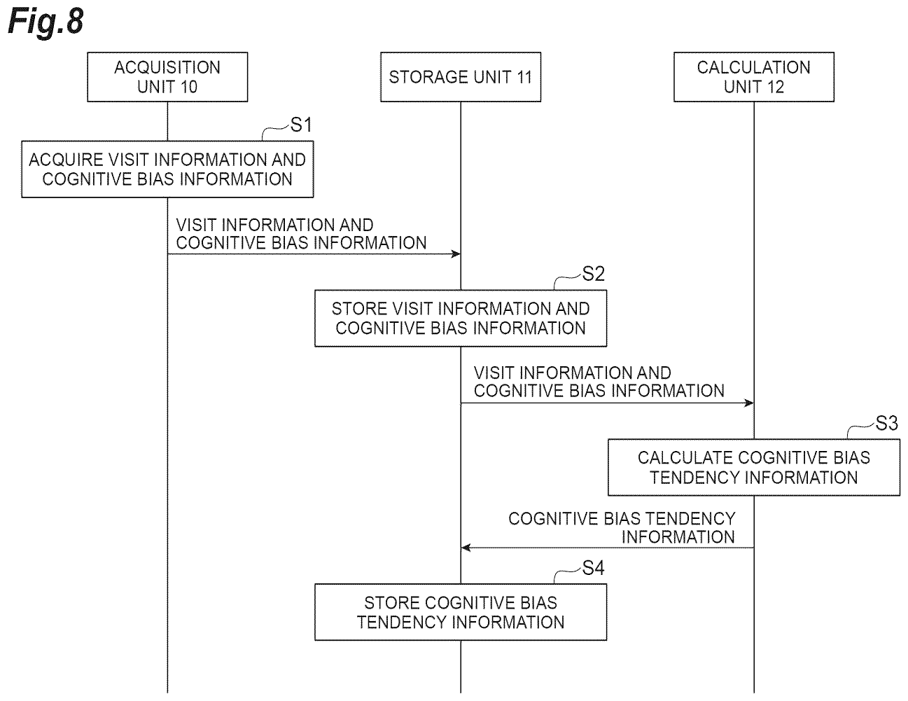

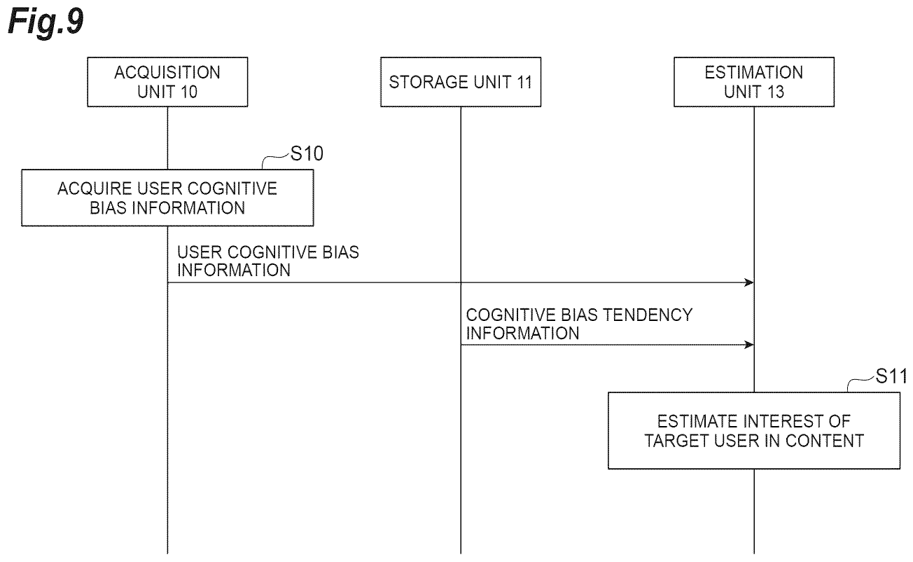

Subsequently, an example of the process executed by the interest estimation device 1 will be described with reference to FIGS. 8 and 9.

FIG. 8 is a sequence diagram illustrating one example of a cognitive bias tendency information calculating process executed by the interest estimation device 1. First, the acquisition unit 10 acquires visit information and cognitive bias information (Step S1). Next, the storage unit 11 stores the visit information and the cognitive bias information acquired in S1 (Step S2). Next, the calculation unit 12 calculates cognitive bias tendency information (a score of a cognitive bias indicating easiness with which each content is visited) on the basis of the visit information and the cognitive bias information stored in S2 (Step S3). Next, the storage unit 11 stores the cognitive bias tendency information calculated in S3 (Step S4). In addition, in S3, the calculation unit 12 may use not the visit information and the cognitive bias information stored in S2 but the visit information and the cognitive bias information acquired in S1.

FIG. 9 is a sequence diagram illustrating one example of an interest estimating process executed by the interest estimation device 1. First, the acquisition unit 10 acquires user cognitive bias information (Step S10). Next, the estimation unit 13 estimates interest of a target user in a content on the basis of the user cognitive bias information acquired in S10 and the cognitive bias tendency information stored by the storage unit 11 (estimates a score of each content in the virtual/real world from the cognitive bias) (Step S11). In addition, in S10, the acquisition unit 10 may acquire the user cognitive bias information stored by the storage unit 11. Furthermore, in S11, the estimation unit 13 may use not the cognitive bias tendency information stored by the storage unit 11 but the cognitive bias tendency information calculated in S3 illustrated in FIG. 8 or may use the cognitive bias tendency information stored in S4 illustrated in FIG. 8.

Subsequently, operations and effects of the interest estimation device 1 according to an embodiment will be described.

According to the interest estimation device 1, the storage unit 11 stores cognitive bias tendency information relating to a cognitive bias present in the tendency of a user expressing interest in a predetermined content, the acquisition unit 10 acquires user cognitive bias information relating to a cognitive bias of a target user who is a user to be targeted, and the estimation unit 13 estimates interest of the target user in the content on the basis of the cognitive bias tendency information stored by the storage unit 11 and the user cognitive bias information acquired by the acquisition unit 10. By employing such a configuration, on the basis of a cognitive bias of a user, interest of this user in a content can be estimated.

In addition, according to the interest estimation device 1, the cognitive bias tendency information includes information relating to a cognitive bias present in the tendency of a user expressing interest in the content in a virtual world, and the estimation unit 13 may estimate the interest of the target user in the content in the virtual world. According to this configuration, interest of the target user in a content in the virtual world can be estimated.

In addition, according to the interest estimation device 1, the cognitive bias tendency information includes information relating to a cognitive bias present in the tendency of a user expressing interest in a content in the virtual world and information relating to a cognitive bias present in the tendency of a user expressing interest in the content in a real world, and the estimation unit 13 may estimate interest of a target user in a content in the virtual world and interest of the target user in a content in the real world. By employing such a configuration, interest of a target user in a content in the virtual world and interest of the target user in a content in the real world can be estimated (simultaneously, in calculation of one time).

In addition, according to the interest estimation device 1, the calculation unit 12 may calculate the cognitive bias tendency information on the basis of information relating to accesses to the content from a plurality of users and information relating to a cognitive bias of this user, and the storage unit 11 may store the cognitive bias tendency information calculated by the calculation unit 12. By employing such a configuration, cognitive bias tendency information can be calculated more easily and more assuredly.

In addition, according to the interest estimation device 1, the cognitive bias tendency information includes a degree of cognitive bias present in the tendency of a user expressing interest in a content, the user cognitive bias information includes a degree of cognitive bias of the target user, and the estimation unit 13 may estimate interest of the target user in the content on the basis of the degree of cognitive bias included in the cognitive bias tendency information and the degree of cognitive bias included in the user cognitive bias information. By employing such a configuration, interest can be estimated on the basis of each degree more easily and more assuredly.

In addition, according to the interest estimation device 1, the estimation unit 13 may estimate interest of the target user in the content on the basis of a difference between the degree of cognitive bias included in the cognitive bias tendency information and the degree of cognitive bias included in the user cognitive bias information. By employing such a configuration, the interest can be estimated more accurately on the basis of the difference between the degrees.

In addition, according to the interest estimation device 1, the cognitive bias tendency information may include information relating to a plurality of cognitive biases present in the tendency of a user expressing interest in the content, and the user cognitive bias information may include information relating to a plurality of cognitive biases of the target user. By employing such a configuration, the interest can be estimated more accurately on the basis of a plurality of cognitive biases.

As a background, during the COVID-19 pandemic, the metaverse has been gaining significant attention. In a virtual world, by guiding a user to an appropriate content on an individual level, benefits can be brought to both users and producers. The behavior of a person depends on attributes, tastes and preferences, and cognitive biases. This applies also to a virtual world.

There is a problem in that behaviors and tastes and preferences do not necessarily coincide with each other in the real world and a virtual world. For example, a person who is reserved in the real world tends to prefer communication in the virtual world. For this reason, promotions as in the real world are not necessarily be effective in the virtual world. In addition, the way behavioral data is collected in virtual and real worlds differs for each user.

According to the interest estimation device 1, by estimating scores of behaviors/tastes and preferences in the real and virtual worlds from cognitive biases, promotions that are appropriate to both the virtual and real worlds can be performed.

According to the interest estimation device 1, scores of cognitive biases indicating easiness in visit to each content in the virtual/real worlds can be calculated. For example, a content is a music event, an apparel shop, or the like. According to the interest estimation device 1, a preference score of each content in the virtual/real world can be calculated on the basis of a cognitive bias for an unknown user.

The interest estimation device 1 is also a system that calculates preference scores in the virtual and real worlds on the basis of cognitive biases and enables different approaches in the virtual and real worlds. The interest estimation device 1 may calculate a preference score of each content in the real world from cognitive biases or calculate a preference score of each content in the virtual world from cognitive biases or may use both the methods.

The interest estimation device 1 according to the present disclosure has the following configurations.
[1] An interest estimation device comprising: a storage unit configured to store cognitive bias tendency information relating to a cognitive bias present in tendency of a user expressing interest in a predetermined content; an acquisition unit configured to acquire user cognitive bias information relating to a cognitive bias of a target user who is a user to be targeted; and an estimation unit configured to estimate interest of the target user in the content on the basis of the cognitive bias tendency information stored by the storage unit and the user cognitive bias information acquired by the acquisition unit.
[2] The interest estimation device described in [1], in which the cognitive bias tendency information comprises information relating to a cognitive bias present in tendency of a user expressing interest in the content in a virtual world, and the estimation unit estimates the interest of the target user in the content in the virtual world.
[3] The interest estimation device described in [1] or [2], in which the cognitive bias tendency information comprises information relating to a cognitive bias present in tendency of a user expressing interest in the content in a virtual world, and information relating to a cognitive bias present in tendency of a user expressing interest in the content in a real world, and the estimation unit estimates interest of the target user in the content in the virtual world and interest of the target user in the content in the real world.
[4] The interest estimation device described in any one of [1] to [3], further comprising a calculation unit configured to calculate the cognitive bias tendency information on the basis of information relating to accesses to the content from a plurality of users and information relating to a cognitive bias of the user, and the storage unit stores the cognitive bias tendency information calculated by the calculation unit.
[5] The interest estimation device described in any one of [1] to [4], in which the cognitive bias tendency information comprises a degree of cognitive bias present in tendency of a user expressing interest in the content, the user cognitive bias information comprises a degree of cognitive bias of the target user, and the estimation unit estimates interest of the target user in the content on the basis of the degree of cognitive bias comprised in the cognitive bias tendency information and the degree of cognitive bias comprised in the user cognitive bias information.
[6] The interest estimation device described in [5], in which the estimation unit estimates interest of the target user in the content on the basis of a difference between the degree of cognitive bias comprised in the cognitive bias tendency information and the degree of cognitive bias comprised in the user cognitive bias information.
[7] The interest estimation device described in any one of [1] to [6], in which the cognitive bias tendency information comprises information relating to a plurality of cognitive biases present in tendency of a user expressing interest in the content, and the user cognitive bias information comprises information relating to a plurality of cognitive biases of the target user.

Each block diagram used for description of the embodiment described above illustrates blocks in units of functions. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

As functions, there are deciding, determining, judging, computing, calculating, processing, deriving, inspecting, searching, checking, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like, and the functions are not limited thereto. For example, a functional block (constituent unit) enabling transmission to function is referred to as a transmitting unit or a transmitter. As described above, a method for realizing all the functions is not particularly limited.

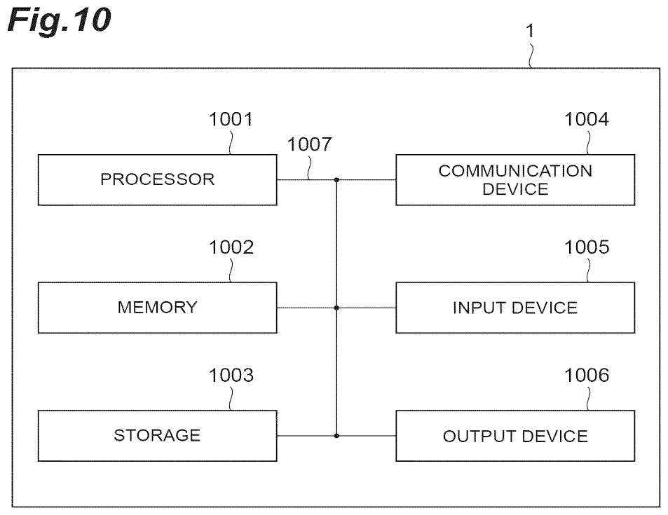

For example, the interest estimation device 1 and the like according to one embodiment of the present disclosure may function as a computer that performs the process of the interest estimation method according to the present disclosure. FIG. 10 is a diagram illustrating an example of the hardware configuration of the interest estimation device 1 according to one embodiment of the present disclosure. The interest estimation device 1 described above, physically, may be configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the interest estimation device 1 may be configured to include one or a plurality of devices illustrated in the drawing and may be configured without including some of these devices.

Each function of the interest estimation device 1 may be realized when the processor 1001 performs an arithmetic operation by causing predetermined software (a program) to be read onto hardware such as the processor 1001, the memory 1002, and the like, controls communication using the communication device 1004, and controls at least one of data reading and data writing for the memory 1002 and the storage 1003.

The processor 1001, for example, controls the entire computer by operating an operating system. The processor 1001 may be configured by a central processing unit (CPU) including an interface with peripheral devices, a control device, an arithmetic operation device, a register, and the like. For example, the acquisition unit 10, the calculation unit 12, the estimation unit 13, and the like described above may be realized by the processor 1001.

In addition, the processor 1001 reads a program (program code), a software module, data, and the like from at least one of the storage 1003 and the communication device 1004 into the memory 1002 and executes various processes in accordance with these. As the program, a program causing a computer to execute at least some of the operations described in the embodiment described above is used. For example, the acquisition unit 10, the calculation unit 12, and the estimation unit 13 may be realized by a control program that is stored in the memory 1002 and operated by the processor 1001, and other functional blocks may be realized similarly as well. Although the various processes described above have been described as being executed by one processor 1001, the processes may be executed simultaneously or sequentially by two or more processors 1001. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable for performing a radio communication method according to one embodiment of the present disclosure.

The storage 1003 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including at least one of the memory 1002 and a storage 1003, a server, or any other appropriate medium.

The communication device 1004 is hardware (a transmission/reception device) for performing inter-computer communication through at least one of a wired network and a wireless network and, for example, may be called also a network device, a network controller, a network card, a communication module, or the like. The communication device 1004, for example, in order to realize at least one of frequency division duplex (FDD) and time division duplex (TDD), may be configured to include a high frequency switch, a duplexer, a filter, a frequency synthesizer, and the like. For example, the acquisition unit 10, the calculation unit 12, the estimation unit 13, and the like described above may be realized using the communication device 1004.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

In addition, devices such as the processor 1001, the memory 1002, and the like are connected using a bus 1007 for communication of information. The bus 1007 may be configured as a single bus or buses different between devices.

In addition, the interest estimation device 1 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of such hardware components.

Notification of information is not limited to an aspect/embodiment described in the present disclosure and may be performed using a difference method.

Each aspect/embodiment described in the present disclosure may be applied to at least one of long term evolution (LTE), LTE-advanced (LTE-A), Super 3G, IMT-advanced, 4G (a 4th generation mobile communication system), 5G (a 5th generation mobile communication system), future ratio access (FRA), new radio (NR), W-CDMA (Registered trademark), GSM (registered trademark), CDMA 2000, ultra mobile broadband (UMB), IEEE 802.11 (Wi-Fi (registered trademark)), IEEE 802.16 (WiMAX (registered trademark), IEEE 802.20, ultra-wideband (UWB), Bluetooth (registered trademark), a system using another appropriate system and a next generation system extended based on these. In addition, a plurality of systems may be combined (for example, a combination of at least one of LTE and LTE-A and 5G or the like) for an application.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology such as infrared rays, radio waves, microwaves, or the like, at least one of such a wiring technology and a radio technology is included in the definition of the transmission medium.

Information, a signal, and the like described in the present disclosure may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in the present disclosure and a term that is necessary for understanding the present disclosure may be substituted with terms having the same meaning or a meaning similar thereto.

Terms such as “system” and “network” used in the present disclosure are interchangeably used.

In addition, information, a parameter, and the like described in the present disclosure may be represented using absolute values, relative values with respect to predetermined values, or other corresponding information.

A name used for each parameter described above is not limited in any aspect. In addition, numerical equations using such parameters may be different from those that are explicitly disclosed in the present disclosure.

Terms such as “determining” used in the present disclosure may include various operations of various types. The “deciding” and “determining”, for example, may include a case in which judging, calculating, computing, processing, deriving, investigating, looking up, search, and inquiry (for example, looking up a table, a database, or any other data structure), or ascertaining is regarded as “deciding” and “determining”. In addition, “deciding” and “determining” may include a case in which receiving (for example, receiving information), transmitting (for example, transmitting information), input, output, or accessing (for example, accessing data in a memory) is regarded as “deciding: and “determining”. Furthermore, “deciding” and “determining” may include a case in which resolving, selecting, choosing, establishing, comparing, or the like is regarded as “deciding” and “determining”. In other words, “deciding” and “determining” includes a case in which a certain operation is regarded as “deciding” and “determining”. In addition, “deciding (determining)” may be rephrased with “assuming”, “expecting”, “considering”, and the like.

Terms such as “connected” or “coupled” or all the modifications thereof mean all the kinds of direct or indirect connection or coupling between two or more elements and may include presence of one or more intermediate elements between two elements that are mutually “connected” or “coupled”. Coupling or connection between elements may be physical coupling or connection, logical coupling or connection, or a combination thereof. For example, “connection” may be rephrased with “access”. When used in the present disclosure, two elements may be considered as being mutually “connected” or “coupled” by using one or more wires and at least one of a cable and a print electric connection and, as several non-limiting and non-comprehensive examples, by using electromagnetic energy such as electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “on the basis of at least.”

In the present disclosure, in a case in which names such as “first”, “second”, and the like is used, referring to each element does not generally limit the amount or the order of such an element. Such names may be used in the present disclosure as a convenient way for distinguishing two or more elements from each other. Accordingly, referring to the first and second elements does not mean that only the two elements are employed therein or the first element should precede the second element in a certain form.

“Means” in the configuration of each device described above may be substituted with “unit”, “circuit”, “device”, or the like.

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may means that “A and B are different from each other”. In addition, the term may mean that “A and B are different from C”. Terms “separated”, “combined”, and the like may be interpreted similar to “different”.

### REFERENCE SIGNS LIST

1 . . . Interest estimation device, 10 . . . Acquisition unit, 11 . . . Storage unit, 12 . . . Calculation unit, 13 . . . Estimation unit, 1001 . . . Processor, 1002 . . . Memory, 1003 . . . Storage, 1004 . . . Communication device, 1005 . . . Input device, 1006 . . . Output device, 1007 . . . Bus.

1. An interest estimation device comprising processing circuitry configured to:
store cognitive bias tendency information relating to a cognitive bias present in tendency of a user expressing interest in a predetermined content;
acquire user cognitive bias information relating to a cognitive bias of a target user who is a user to be targeted; and
estimate interest of the target user in the content on the basis of the stored cognitive bias tendency information and the acquired user cognitive bias information.

2. The interest estimation device according to claim 1,
wherein the cognitive bias tendency information comprises information relating to a cognitive bias present in tendency of a user expressing interest in the content in a virtual world, and
wherein the processing circuitry is configured to estimate the interest of the target user in the content in the virtual world.

3. The interest estimation device according to claim 1,
wherein the cognitive bias tendency information comprises information relating to a cognitive bias present in tendency of a user expressing interest in the content in a virtual world, and information relating to a cognitive bias present in tendency of a user expressing interest in the content in a real world, and
wherein the processing circuitry is configured to estimate interest of the target user in the content in the virtual world and interest of the target user in the content in the real world.

4. The interest estimation device according to claim 1, wherein the processing circuitry is further configured to calculate the cognitive bias tendency information on the basis of information relating to accesses to the content from a plurality of users and information relating to a cognitive bias of the user, and
wherein the processing circuitry is configured to store the calculated cognitive bias tendency information.

5. The interest estimation device according to claim 1,
wherein the cognitive bias tendency information comprises a degree of cognitive bias present in tendency of a user expressing interest in the content,
wherein the user cognitive bias information comprises a degree of cognitive bias of the target user, and
wherein the processing circuitry is configured to estimate interest of the target user in the content on the basis of the degree of cognitive bias comprised in the cognitive bias tendency information and the degree of cognitive bias comprised in the user cognitive bias information.

6. The interest estimation device according to claim 5, wherein the processing circuitry is configured to estimate interest of the target user in the content on the basis of a difference between the degree of cognitive bias comprised in the cognitive bias tendency information and the degree of cognitive bias comprised in the user cognitive bias information.

7. The interest estimation device according to claim 1,
wherein the cognitive bias tendency information comprises information relating to a plurality of cognitive biases present in tendency of a user expressing interest in the content, and
wherein the user cognitive bias information comprises information relating to a plurality of cognitive biases of the target user.

8. The interest estimation device according to claim 2,
wherein the cognitive bias tendency information comprises information relating to a cognitive bias present in tendency of a user expressing interest in the content in a virtual world, and information relating to a cognitive bias present in tendency of a user expressing interest in the content in a real world, and
wherein the processing circuitry is configured to estimate interest of the target user in the content in the virtual world and interest of the target user in the content in the real world.
